(19) United States
(12) Patent Application Publication
(10) Pub. No.: US 2003/0120999 A1
(43) Pub. Date: Jun. 26, 2003

(54) Calculating in spreadsheet cells without using formulas

(76) Inventors: Michelle A. Miller, Plano, TX (US); P. Gayle Mujica, Allen, TX (US); Roger S. Falaster, Murphy, TX (US); Lisabeth C. Main, Plano, TX (US); Lisa Smoot, Dallas, TX (US); Bea R. Aton, Dallas, TX (US)

Correspondence Address: TEXAS INSTRUMENTS INCORPORATED, P O BOX 655474, M/S 3999, DALLAS, TX, 75265

(21) Appl. No.: 10/028,327

(22) Filed: Dec. 21, 2001

(51) Int. Cl. G09G 5/00

(52) U.S. Cl. 715/503

(57) ABSTRACT

A computer spreadsheet application program on a graphing calculator or other computer that allows the user to calculate and enter results inside a spreadsheet cell without using or entering a formula. Similarly, other embodiments include the same user interface functionality in a ROM software application package that is executed on a graphing calculator or other handheld device.

### TECHNICAL FIELD OF THE INVENTION

This invention relates to electronic computing devices and spreadsheet software on those devices, and more particularly to a calculator that has a spread sheet that allows the user to calculate and enter results inside a spreadsheet cell without using or entering a formula

### BACKGROUND OF THE INVENTION

Electronic calculators have become a common tool for teaching students mathematics. In particular, the advantages of graphing calculators are being utilized in the classroom. Graphing calculators are characterized by a larger screen, which permits the entry of mathematical expressions in a logical format. They also permit graph displays and table displays. They have sophisticated programming capability. They often permit data transmission to other computing devices, directly or via a data storage medium, as well as data collection via various interface protocols.

Particular calculator models are often designed for particular educational levels. For example, a calculator for middle school students might have less advanced features than one designed for older students. However, regardless of the level for which a calculator is designed, a continual goal in designing them is to provide a logical and easy to use interface. Another goal of the user interface is to assist the teacher in instructing students in the classroom environment.

### SUMMARY OF THE INVENTION

The present invention seeks to improve the user interface for a spreadsheet application. This spreadsheet improvement may be helpful in any type of spreadsheet, but is particularly useful in the classroom environment. The disclosed embodiment is a spreadsheet on a handheld calculator but the invention is applicable and useful for all spreadsheet type applications. The invention introduces an improved user interface to allow the user to calculate and enter results inside a spreadsheet cell without using or entering a formula

A particular problem with prior art computer spreadsheets is calculation in spreadsheet cells is done only with formulas. The prior art formula is always dsplayed in the cell edit line when the cursor is over the cell. The present invention allows the user to easily make calculations within a cell and have the results stored in the cell rather than the formula used to calculate those results.

An embodiment of the present invention is an application program on a graphing calculator or other computer, which allows the user to calculate and enter results inside a spreadsheet cell without using or entering a formula. Similarly, other embodiments include the same user interface functionality in a ROM software application package that is executed on a graphing calculator or other handheld device. The calculator in the present invention may otherwise be a conventional graphing calculator.

### BRIEF DESCRIPTION OF THE DRAWINGS

FIG. 1 illustrates the front panel of a prior art calculator 10 which incorporates the invention.

FIG. 2 illustrates the basic screen layout of a spreadsheet on a handheld device according to the present invention.

FIGS. 3a-g illustrate the calculating within a spreadsheet cell according to the present invention.

### DETAILED DESCRIPTION OF THE INVENTION

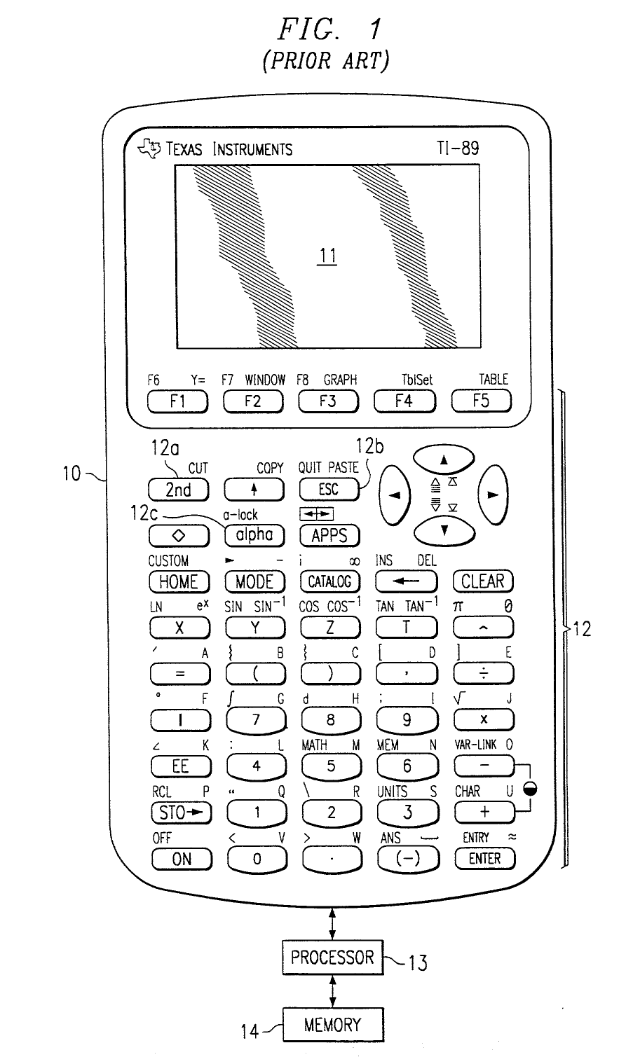

FIG. 1 illustrates the front panel of a calculator 10, which incorporates the features of the present invention. Calculator 10 is described herein in terms of particular software and hardware features of the TI-89, a commercially available graphing calculator manufactured by Texas Instruments Incorporated. Apart from the features of the present invention, many of the features of calculator 10 described herein are typical of graphing calculators, while other features are unique to the TI-89 and TI92 Plus “family” of TI calculators. The use of the TI-89 is for purposes of description, and does not limit the invention. The features that are the subject of the present invention could be incorporated into other calculators that provides graphical displays, or they could be incorporated into other computer based teaching tools and handheld computers.

In FIG. 1, the screen 11 of calculator 10 has a “graphical display”, as that term is used herein. In addition to the ability to draw graphical displays of various types, some of the software features of calculator 10 include, software applications loading and storage, keystroke programming. It also permits data collection, display and analysis.

Various hardware features include a large pixel screen 11, which is 100×160 pixels. A keypad 12 has various keys for data and command entry, some of which are used to implement the invention and are described herein. The calculator includes a processor 13 connected to a memory unit 14 a 256K byte RAM and 721K byte application space. Other features are an I/O port for data linking, and a unit-to-unit link cable connection capability.

As is typical of calculators, calculator 10 has a secondary function key, 2nd key 12a, which permits other keys to have two functions. For example, by pressing 2nd key 12a and then ESC/QUIT key 12b, the calculator performs the QUIT function. For simplicity of explanation herein, a key having two functions is referred to in terms of the function appropriate for the context, i.e., when discussing the QUIT function, the ESC/QUIT key 12b is referred to as the QUIT key 12b. Similarly, calculator 10 has an Alpha key 12c, which when depressed makes the other keys subsequently depressed to input an alpha character.

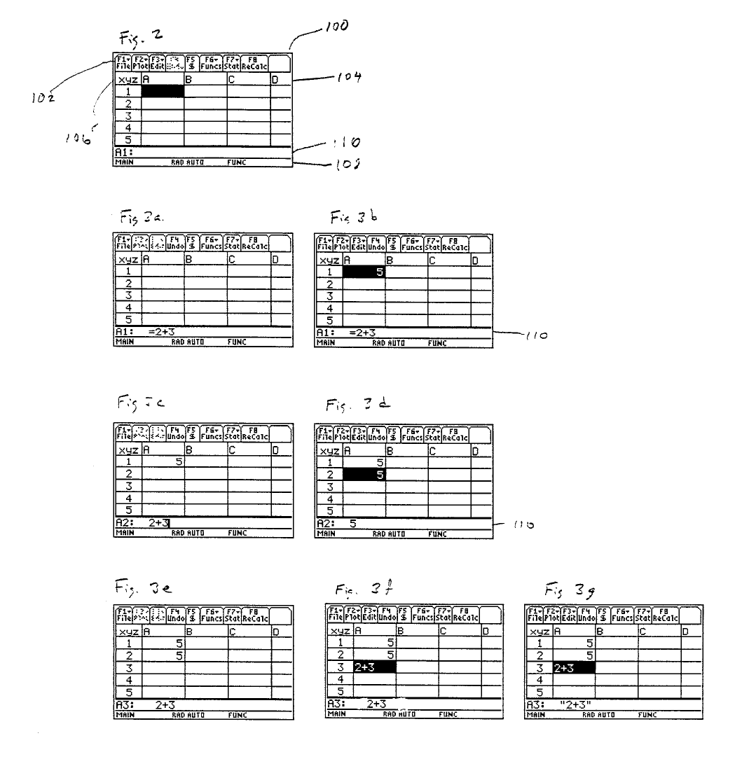

FIG. 2 illustrates an example of the screen display of an embodiment of the present invention. This screen display is typical for the calculator illustrated in FIG. 1 while running an application program called “Cellsheet.” Cellsheet incorporates a spreadsheet program for a handheld device such as a graphing calculator according to the present invention. Cellsheet combines spreadsheet functionality with the power of a calculator.

The screen display 100 of FIG. 2 shows the screen display after initiating the Cellsheet program. The top area of the screen display 100 shows a menu bar 102 with function tabs for each of the function keys F1 through F8. The main portion of the screen is the spreadsheet rows and columns 104. In this embodiment, there are 64 columns labeled A through BL, where columns A through D are visible on the initial display. The rows are numbered, in this case 1-999, with rows 1 through 5 displayed initially. The upper left hand corner of the spreadsheet 106 identifies name of the current worksheet (XYZ).

On the bottom of the screen 100 is a status line 108. The status line shows various calculator status items such as the open folder (MAIN) and display modes (RAD and AUTO). Above the status bar is the cell edit line 110. The edit line shows the identification of the selected cell or cells and the contents of the cell. In FIG. 2, the cell edit line shows the selected cell as cell A1, and the contents as empty. This line is also used to edit the contents of the cell.

The Cellsheet application program introduces an improved user interface to allow the user to calculate and enter results inside a spreadsheet cell without using or entering a formula. A particular problem with prior art computer spreadsheets is calculation in spreadsheet cells is done only with formulas. Further, in the prior art spreadsheet, the formula is always stored in the cell and displayed in the cell edit line when the cursor is over the cell. The present invention allows the user to easily make calculations within a cell and have the results stored in the cell rather than the formula used to calculate those results. It was discovered that in many cases the user may not want or need to store the formula or calculations. In the classroom situation, the teacher may want to hide the calculation or formula that produced the resulting cell entry. Other reasons to not store the formula or calculation include reducing the calculation time to regenerate the spreadsheet display, and reduced memory needed for storing the spreadsheet. These advantages of the present invention were not found in the prior art spreadsheets.

In a preferred embodiment, an expression can be entered into the spreadsheet in three ways. The first is the prior art method, where an “=” or “+” sign proceeds the expression (e.g. =2+3). FIG. 3a illustrates entering a formula according to this prior art method. FIG. 3b shows the contents of the cell retains the formula, as shown on the cell edit line 110, while the result is shown in cell A1.

In the second case, if the expression is not proceeded by a space, an “=” or “+” sign or other reserved characters, then the expression is evaluated, and the result is stored in the cell and not the expression. FIG. 3c illustrates entering an expression (2+3) on the cell edit line 110 according to this method. FIG. 3d shows the result of FIG. 3c after pressing the enter key. The contents of the cell does not retain the formula or expression, as shown on the cell edit line 110. Only the result of the expression or formula (5) is stored in the cell.

The third case is when the expression is proceeded by a space or quotation marks. In this case, the expression is stored in the cell in the form of text, and no result is calculated. FIG. 3e illustrates entering an expression (2+3) on the cell edit line 110 according to this method by preceding the expression with a space. FIG. 3f shows the result of FIG. 3e after pressing the enter key. The text expression is stored in the cell, as shown on the cell edit line 110 and in the cell display. No result of the expression is calculated. In another example, a text expression can be entered by enclosing the expression with quotation marks. This method is shown in FIG. 3g.

Other Embodiments

Although the present invention has been described in detail, it should be understood that various changes, substitutions, and alterations could be made hereto without departing from the spirit and scope of the invention as defined by the appended claims.

The described embodiment of the present invention is an application program on a graphing calculator, which allows the user to A particular problem with prior art computer spreadsheets is calculation in spreadsheet cells is done only with formulas. The prior art formula is always displayed in the cell edit line when the cursor is over the cell. The present invention allows the user to easily make calculations within a cell and have the results stored in the cell rather than the formula used to calculate those results. Similarly, other embodiments include the same user interface functionality in a ROM software application package that is executed on a graphing calculator or other handheld device.

What is claimed is:

1. A user interface for a spreadsheet computer program comprising:
a spreadsheet display having rows and columns of cells;
a cursor operable by a user input which indicates at least one currently selected cell; and
a cell edit line which allows the user to enter a mathematical expression with a sequence of entries, wherein the user interface stores the results of the mathematical expression in the selected cell but not the mathematical expression and displays the result in the cell.

2. The user interface of claim 1, wherein an entry preceded with a “+” or “=” sign is stored as an expression or formula and the result displayed in the cell.

3. The user interface of claim 2, wherein an entry preceded with a special symbol is stored as text and the text displayed in the cell.

4. The user interface of claim 3, wherein the special symbol is selected from the following: a quotation mark, and space.

5. A handheld computing device comprising:
a screen capable of displaying spreadsheet rows and columns for a spreadsheet application;
an input device for operating the computing device and entering user responses;
a processor for executing programming that provides a user interface to the spreadsheet application wherein the user interface further comprises:
a cursor operable by user input through the input device, wherein the cursor indicates at least one currently selected cell; and
a cell edit line which allows the user to enter a mathematical expression with a sequence of entries, wherein the user interface stores the results of the mathematical expression in the selected cell but not the mathematical expression and displays the result in the cell.

6. The handheld computing device of claim 5, wherein an entry preceded with a “+” or “=” sign is stored as an expression or formula and the result displayed in the cell

7. The handheld computing device of claim 5, wherein an entry preceded with a special symbol is stored as text and the text displayed in the cell.

8. The handheld computing device of claim 7, wherein the special symbol is selected from the following: a quotation mark, and space.

9. A graphing calculator comprising:
a screen capable of displaying spreadsheet rows and columns for a spreadsheet application;
an input device for operating the computing device and entering user responses;
a processor for executing programming that provides a user interface to the spreadsheet application wherein the user interface further comprises:
a cursor operable by user input through the input device, wherein the cursor indicates at least one currently selected cell; and
a cell edit line which allows the user to enter a mathematical expression with a sequence of entries, wherein the programing stores the results of the mathematical expression in the selected cell but not the mathematical expression and displays the result in the cell.

10. The device of claim 9, wherein an entry preceded with a “+” or “=” sign is stored as an expression or formula and the result displayed in the cell

11. The device of claim 9, wherein an entry preceded with a special symbol is stored as text and the text displayed in the cell.

12. The device of claim 11, wherein the special symbol is selected from the following: a quotation mark, and space.
